(19) United States
(12) Patent Application Publication
(10) Pub. No.: US 2002/0178209 A1
(43) Pub. Date: Nov. 28, 2002

(54) Method and device for determining the load of a computing element

(76) Inventor: Jens Boettcher, Schwieberdingen (DE)

Correspondence Address: KENYON & KENYON, ONE BROADWAY, NEW YORK, NY, 10004, US

(21) Appl. No.: 10/092,225

(22) Filed: Mar. 5, 2002

(30) Foreign Application Priority Data
Mar. 5, 2001 (DE) 101 10 444.8

(51) Int. Cl. G06F 3/00

(52) U.S. Cl. 709/105; 710/18

(57) ABSTRACT

A method and a device for determining the load of a computing element. A computer program is executed on the computing element. The computer program is subdivided into several tasks, and each task includes at least one process. To be able to determine, on the one hand, the load of the computing element as precisely and reliably as possible and with a high dynamic performance and, on the other hand, the processing time of processes or tasks of the computer program independently of interruptions by processes of higher priority tasks, it is proposed that a time interval be selected such that at least one task is started and ended during the time interval; the running time of the task be determined during the time interval after completion of the task or every task; and the running time of the task or of every task be subtracted from the determined running time in the event that the completed task was interrupted by at least one additional task.

### FIELD OF THE INVENTION

The present invention relates to a method and a device for determining the load of a computing element. A computer program is executed on the computing element. The computer program is subdivided into several tasks, and each task includes at least one process.

Moreover, the present invention relates to a memory element, in particular a read only memory, a random access memory, or a flash memory. Stored in the memory element is a computer program that is executable on a computing element, particularly on a microprocessor.

Finally, the present invention relates to a computer program that is executable on a computing element, in particular on a microprocessor.

### BACKGROUND INFORMATION

A computer program in the sense of the present invention is, for example, a control program used for controlling/regulating technical processes and other functions in a motor vehicle. The control program is executable on a computing element, in particular on a microprocessor, of a control unit of a motor vehicle. The control program is subdivided into several tasks, and each task includes at least one process. The individual tasks are assigned different priorities. The tasks are able to mutually interrupt one another. The control program may be executed in a cooperative or in a preemptive mode. The present invention applies equally to tasks being executed by the computing element in the cooperative and in the preemptive mode.

Processing individual tasks of a control program in the cooperative mode means that, given differently prioritized tasks, a higher prioritized task to be executed causes a lower prioritized task currently being executed to be interrupted. In contrast to the preemptive mode, in which a higher prioritized task to be executed interrupts a process of a lower prioritized task currently being executed, in the cooperative mode, the higher prioritized task waits until the end of the process of the lower prioritized task currently being executed. Only then is the lower prioritized task interrupted and the higher prioritized task executed. When the higher prioritized task is completed, the lower prioritized task is continued from the process before which it was interrupted.

Processing tasks of a control program in cooperative mode is known from German Published Patent Application No. 195 00 957. Interrupting a lower prioritized task with a higher prioritized task belongs to the duties of a multitasking operating system. Such a multitasking operating system, which supports the cooperative mode as well as the preemptive mode when executing a control programs is, for example, the real time operating system ERCOS^{EK} of the firm ETAS, Entwicklungs- und Applikationswerkzeuge für elektronische Systeme (Development and Application Tools for Electronic Systems) GmbH & Co. KG, Stuttgart, Germany, (cf. ETAS GmbH & Co. KG: ERCOS^{EK} V2.0.0 Manual, Stuttgart, 1998). Specific reference is made to German Published Patent Application No. 195 00 957 and to the ERCOS^{EK} handbook.

When in operation, a computing element is loaded to a greater or lesser degree depending on the number of process calls and the processing time of the called processes. In the case of time-critical or safety-critical applications, such as controlling X-by-wire applications steer-by-wire, brake-by-wire, etc.) in a motor vehicle, the computing element should not be too significantly loaded or even overloaded, since given overloading, proper processing of the program is no longer able to be ensured. To be able to monitor the load of the computing element and take suitable countermeasures in response to a too significant load, it is known to determine the load of the computing element. Countermeasures are, for example, to delay the call of less time-critical or safety-critical processes in a targeted manner in order to enable particularly time-critical or safety-critical processes to be called and executed.

Different methods are known for determining the load of a computing element. For example, it is known from German Published Patent Application No. 197 57 876 to always call a special no-load program when the computing element is not loaded, i.e., the computing element is not executing a process. The load of the computing element is able to be determined from the running time or the number of calls of the no-load program during a predefinable time interval (load_{computingelement} [%]=100%-running time_{no-loadprogram} [%]). The calculated load represents an average value filtered over a longer time interval. For this reason, the load of the computing element is only able to be determined with a very low dynamic performance using the known method.

A further disadvantage of the known method is that, given a significant load, the no-load program is only seldomly called and executed on the computing element. If the considered time interval is defined to be too short, it may occur that the no-load program is not called in the time interval and a 100% load is determined although the actual load is less. Likewise, given a small load of the computing element, the no-load program is almost always called, and is only not called when processes of the computer program are being executed. When the considered time interval is defined to be too short, it may occur that the no-load program is constantly executed in the time interval and a 0% load is determined although the actual load is greater.

### SUMMARY OF THE INVENTION

An object of the present invention is, on the one hand, to determine the load of a computing element as precisely and reliably as possible and with a high dynamic performance, and, on the other hand, to determine the processing time of processes or tasks of a computer program executed on the computing element independently of interruptions by processes of higher prioritized tasks.

The present invention proposes the following to achieve this object by:

selecting a time interval such that at least one task is started and completed during the time interval;

determining the running time of the task during the time interval after the task or every task is ended; and

subtracting the running time of the task or of every additional task from the determined running time in the event that the completed task is interrupted by at least one additional task.

The uninterrupted processing times of every task active in the computing element are able to be determined using the method of the present invention. This is carried out by inserting suitable program commands at the start and at the end of the execution of the task of the computer program. By adding the processing time of all tasks ended within the predefinable time interval and subsequently normalizing to the time interval, the percentage load of the computing element is able to be determined with almost any dynamic performance and without filtering or averaging.

In accordance with an advantageous further refinement of the present invention, it is proposed that

the time interval be selected such that at least two tasks are started and completed during the time interval; and

the running times of the completed tasks be determined in the sequence in which the tasks are completed.

In accordance with an preferred specific embodiment of the present invention, it is proposed that

a variable (Unterbr) be set to zero at the start of the method;

the running time of the completed task be determined using the equation t_{runningtime}=t_{end}−tₛₜₐᵣₜ−(Unterbr_{end}−Unterbrₛₜₐᵣₜ); and

a new value be determined for the variable using the equation Unterbr=Unterbrₛₜₐᵣₜ+(t_{end}−tₛₜₐᵣₜ),

tₛₜₐᵣₜ being the value of a time counter running while the computer program is being executed at the start of the task, t_{end} being the value of the time counter after the task is completed, Unterbrₛₜₐᵣₜ being the value of the variable at the start of the task, and Unterbr_{end} being the value of the variable after the task is ended.

Advantageously, for determining the load of the computer element after the predefined time interval, the determined running times of the tasks are added and set in proportion to the time interval.

Preferably, the determined running times of the individual tasks are each stored in an individual memory location of the computing element, preferably in a random access memory (RAM) memory location. For a subsequent calculation of the load, it should be ensured that current running time values are available in the memory locations. This may be achieved, for example, by erasing the memory locations after the load is calculated or by writing over the content of the memory locations after the calculation, e.g. with zero or a current running time value for the subsequent calculation.

Realizing the method of the present invention in the form of a memory element is particularly important. In this context, a computer program that is executable on a computing element, in particular on a microprocessor, and is suitable for carrying out the method according to the present invention is stored on the memory element. Therefore, in this case, the present invention is realized by a computer program stored on the memory element, so that this memory element provided with the computer program represents the present invention in the same way as the method for whose execution the computer program is suitable. In particular, an electrical storage medium, for example, a read only memory, a random access memory, or a flash memory, may be used as the memory element.

The present invention also relates to a computer program that is suitable for carrying out the method according to the present invention when it is executed on a computing element, in particular on a microprocessor. In this context, it is particularly preferred for the computer program to be stored on a memory element, in particular on a flash memory.

Starting from the device for determining the load of a computing element of the species recited at the outset, it is proposed as a further way of achieving the object of the present invention that the device

determine the running time of the task during a predefinable time interval after completion of the task or of every task; and

subtract the running time of the task or of every additional task from the determined running time in the event that the completed task was interrupted by at least one additional task.

The device of the present invention is designed, for example, as a control unit of a motor vehicle that is used for controlling/regulating technical processes and other functions in the motor vehicle. The control unit has a computing element, in particular a microprocessor, on which a control program is able to be run. The control program is subdivided into several tasks, and each task includes at least one process. Arrangements for carrying out the method of the present invention are realized in the device. As a result, the uninterrupted processing times of every task active in the computing element are able to be determined. Adding the processing times of all tasks completed within the predefinable time interval and subsequently normalizing to the time interval also makes it possible to determine the percentage load of the computing element.

### BRIEF DESCRIPTION OF THE DRAWINGS

FIG. 1 is a flow diagram of a control program subdivided into three tasks A, B, C.

FIG. 2 is a flow diagram of an exemplary method according to the present invention, according to a preferred specific embodiment.

FIG. 3 shows an exemplary device according to the present invention for executing the method shown in FIG. 2 according to a preferred specific embodiment.

### DETAILED DESCRIPTION

In FIG. 3, a control unit of a motor vehicle is designated in its entirety by reference numeral 1. Control unit 1 has a computing element that is configured as a microprocessor 2. A computer program is stored on a memory element of control unit 1, the memory element being designed as a flash memory 3. The computer program is designed as a control program for controlling technical processes especially in a motor vehicle. The control program is able to be executed on microprocessor 2. For data transmission, a data connection 4, which is designed as a bus line, for example, is provided between microprocessor 2 and flash memory 3. Different input variables 5, such as the signals of sensors and of measured-value sensors, are applied to control unit 1. Input variables 5 characterize the condition of the functions to be controlled, the condition of the motor vehicle, or other conditions, such as weather conditions. On the basis of input variables 5, output variables 6, which are used for activating actuators or controllers, are determined in control unit 1. Output variables 6 are setpoint values for control operations or regulating operations, for example.

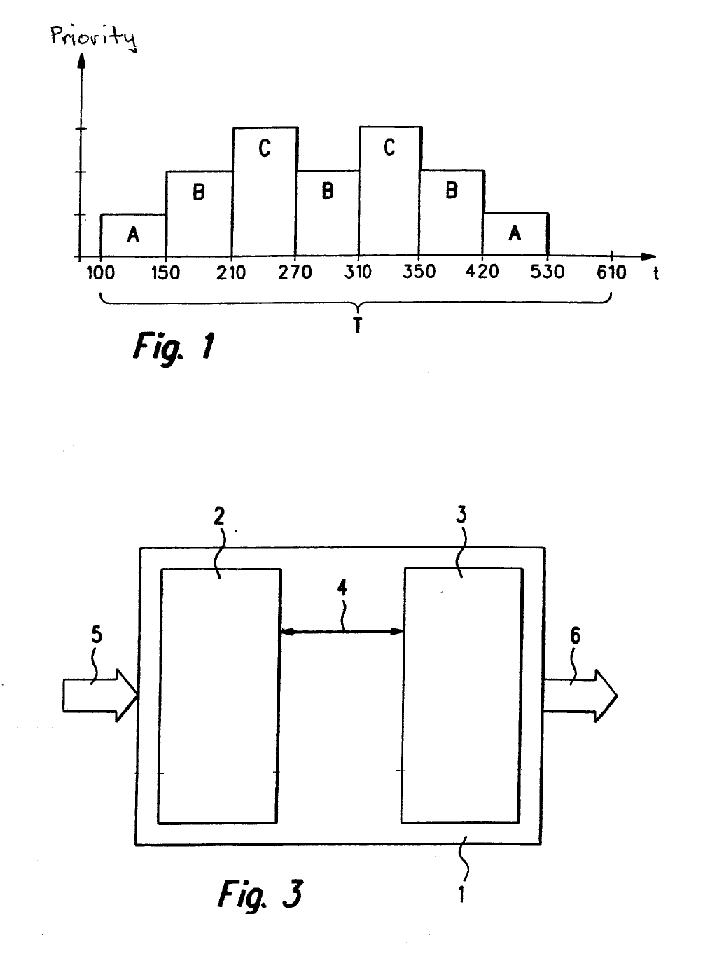

The control program is subdivided into a plurality of tasks A, B, C (see FIG. 1), every task in turn including at least one process. A task A, B, C is called at a certain time or at regular intervals with a certain sampling time and may be executed in a cooperative or a preemptive mode. Every task A, B, C is assigned a certain priority. Task A has the lowest priority, and task C has the highest. If two tasks are called at the same time while the control program is being executed, the priorities of the two tasks are compared and the task having the higher priority is executed first.

If, for example, task A is being executed and task B is to be executed, different scenarios can occur depending on the configuration of the tasks selected by the programmer:

If task A has a higher priority than task B (not the case in FIG. 1), task B is not executed until task A is completed.

If task B has a higher priority than task A (example in FIG. 1), the execution of task A is interrupted, and task B is carried out. If the programmer selected the tasks to be executed in the cooperative mode, task B waits to be executed until the end of the current process of task A. As soon as this process is ended, task A is interrupted, and task B is executed. When task B is completed, task A continues to be executed from the beginning of the process before which task A was interrupted for the execution of task B.

If the programmer selected the tasks to be executed in the preemptive mode, task B interrupts the current process of task A, and task B is immediately executed. Task A is subsequently further executed from the interrupted process.

Interrupting a task with another task having a higher priority belongs to the duties of a multitasking operating system. The running time of the processes fluctuates depending on the load of the computing element on which the control program is executed. For this reason, and for reasons of possible interruptions caused by other tasks, the sequence of process calls may be different for multiple executions of one and the same control program. Therefore, the running times of the individual tasks within a predefinable time interval may be subject to fluctuations.

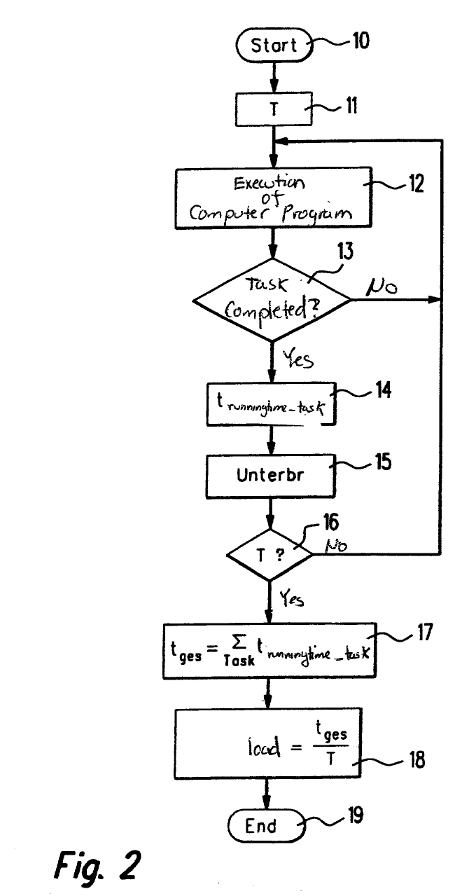

To determine the processing time of processes or task A, B, C of a control program executed on microprocessor 2 independently of interruptions by processes having higher priority tasks, a method according to the present invention is proposed which is shown as a flow diagram in FIG. 2. Using the processing time of the individual processes or tasks A, B, C within a predefinable time interval T, the method of the present invention is also able to precisely and reliably determine the load of microprocessor 2 with a high dynamic performance.

The method begins in a functional block 10. Time interval T is selected in functional block 11. Time interval T is selected such that at least one task A, B, C is started and completed during time interval T. In a functional block 12, the normal execution of the control program (see FIG. 2) on microprocessor 2 is initiated. In a query block 13, a check is performed to determine whether a task was completed. If yes, the processing time t_{runningtime}_{_{—}}ₜₐₛₖ of the completed task is calculated in a functional block 14 using the following equation:

t_{runningtime}_{_{—}}ₜₐₛₖ=t_{end}−tₛₜₐᵣₜ−(Unterbr_{end}−Unterbrₛₜₐᵣₜ),

tₛₜₐᵣₜ being the value of a time counter running during the execution of the computer program at the start of the task, t_{end} being the value of the time counter after the completion of the task, Unterbrₛₜₐᵣₜ being the vale of a variable Unterbr at the start of the task, and Unterbr_{end} being the value of the variable Unterbr after completion of the task.

In a functional block 15, a new value for the variable Unterbr is subsequently calculated using the following equation:

Unterbr=Unterbrₛₜₐᵣₜ+(t_{end}−tₛₜₐᵣₜ)

A check is performed in query block 16 to determine whether or not predefined time interval T has already elapsed. If yes, sum t_{ges} of processing time t_{runningtime}_{_{—}}ₜₐₛₖ of all tasks completed in predefined time interval T is formed in a functional block 17. In a functional block 18, total processing time t_{ges} is then set in proportion to predefined time interval T in order to determine the load of microprocessor 2. The method of the present invention is ended in a functional block 19.

If the result in query block 13 is that no task has ended, or if the result in query block 16 is that predefined time interval T has not yet elapsed, the program branches to functional block 12, where the execution of the control program is continued.

The method of the present invention from FIG. 2 is subsequently explained by way of example on the basis of the control program from FIG. 1. Time interval T is set to T=610−100=510 milliseconds. The variable Unterbr is set to zero. The execution of the control program is subsequently started. The first task completed is task C. The processing time of this task C is determined:

$$\begin{matrix}{t}_{runningtime\_C} = {t}_{end} - {t}_{start} - ( {Unterbr}_{end} - {Unterbr}_{start} ) \\ = 270 - 210 - 0 \\ = 60 milliseconds .\end{matrix}$$

The difference (Unterbr_{end}−Unterbrₛₜₐᵣₜ) is set to zero, since task C was not interrupted. Variable Unterbr is subsequently determined:

$$\begin{matrix}Unterbr = {Unterbr}_{start} + ( {t}_{end} - {t}_{start} ) \\ = 0 + ( 270 - 210 ) \\ = 60 milliseconds\end{matrix}$$

The next task completed is again task C.

For this task C, processing time t_{runningtime}_{_{—}}_{C} and the new value for the variable Unterbr are calculated:

$$\begin{matrix}{t}_{runningtime\_C} = {t}_{end} - {t}_{start} - ( {Unterbr}_{end} - {Unterbr}_{start} ) \\ = 350 - 310 - 0 \\ = 40 milliseconds ,\end{matrix}$$

$$\begin{matrix}Unterbr = {Unterbr}_{start} + ( {t}_{end} - {t}_{start} ) \\ = 60 + ( 350 - 310 ) \\ = 100 milliseconds .\end{matrix}$$

Task B is completed as the next task. For task B, processing time t_{runningtime}_{_{—}}_{B} and the new value for the variable Unterbr are calculated:

$$\begin{matrix}{t}_{runningtime\_B} = {t}_{end} - {t}_{start} - ( {Unterbr}_{end} - {Unterbr}_{start} ) \\ = 420 - 150 - ( 100 - 0 ) \\ = 170 milliseconds ,\end{matrix}$$

$$\begin{matrix}Unterbr = {Unterbr}_{start} + ( {t}_{end} - {t}_{start} ) \\ = 0 + ( 420 - 150 ) \\ = 270 milliseconds .\end{matrix}$$

Finally, task A is completed. Processing time t_{runningtime}_{_{—}}_{A} and the new value for the variable Unterbr are calculated for task A:

$$\begin{matrix}{t}_{runningtime\_A} = {t}_{end} - {t}_{start} - ( {Unterbr}_{end} - {Unterbr}_{start} ) \\ = 530 - 100 - ( 270 - 0 ) \\ = 160 milliseconds ,\end{matrix}$$

$$\begin{matrix}Unterbr = {Unterbr}_{start} + ( {t}_{end} - {t}_{start} ) \\ = 0 + ( 530 - 100 ) \\ = 430 milliseconds .\end{matrix}$$

Sum t_{ges} of the processing time of individual tasks A, B, C is then t_{ges}=430 milliseconds. Therefore, given a predefined time interval T of 510 milliseconds, the result according to the method of the present invention is a load of microprocessor 2 of t_{ges}/T=430/510=0.843 or 84.3%.

The method of the present invention is able to be realized in a simple manner in that the control program is modified such that at the beginning and end of a task additional functionalities are programmed. The additional functionalities at the start of the task include inputting the counter reading of an ongoing time counter and storing the counter reading under variable tₛₜₐᵣₜ. Moreover, at the beginning of the task, the value of the variable Unterbr may be read in and a value may be stored in the variable Unterbrₛₜₐᵣₜ. The additional functionalities at the end of the task include inputting the counter reading of the time counter and storing the counter reading under the variable t_{end}. Moreover, at the end of the task, the value of the variable Unterbr may be read in and a value may be stored in the variable Unterbr_{end}. Furthermore, running time t_{runningtime}_{_{—}}ₜₐₛₖ and the new value for the variable Unterbr are calculated at the end of the task.

The load of a computing element may also be determined by the particularly effective calculation explained in the following. The following calculation results from mathematically converting the calculation explained above. In the case of the proposed particularly effective calculation, only an auxiliary variable auxiliaryvar is used and only four additions need to be performed. The auxiliary variable auxiliaryvar is calculated at the beginning of the task:

Auxiliaryvar=Unterbrₛₜₐᵣₜ−tₛₜₐᵣₜ

Running time t_{runningtime}_{_{—}}ₜₐₛₖ and the variable Unterbr are calculated at the end of the task:

t_{runningtime}_{_{—}}ₜₐₛₖ=t_{end}−Unterbr_{end}+auxiliaryvar

Unterbr=t_{end}+auxiliaryvar.

According to another calculation of the load of the computing element, only two auxiliary variables auxiliaryvar1 and auxiliaryvar2 are needed and only three additions need to be performed. First auxiliary variable auxiliaryvar1 is calculated at the beginning of the task:

auxiliaryvar1=Unterbrₛₜₐᵣₜ−tₛₜₐᵣₜ

Second auxiliary variable auxiliaryvar2, running time t_{runningtime}_{_{—}}ₜₐₛₖ, and the variable Unterbr are calculated at the end of the task:

auxiliaryvar2=t_{end}+auxiliarysvar1

t_{runningtime}_{_{—}}ₜₐₛₖ=auxiliaryvar2−Unterbr_{end}

Unterbr=Hilfsvar2.

What is claimed is:

1. A method for determining a load of a computing element on which a computer program is executed, the computer program being subdivided into a plurality of tasks, each of the plurality of tasks including at least one process, the method comprising:
(A) selecting a time interval such that at least one of the plurality of tasks is started and ended during the time interval;
(B) determining a running time of the at least one of the plurality of tasks during the time interval after a completion of one of the at least one of the plurality of tasks and each of the plurality of tasks; and
(C) if the at least one of the plurality of tasks was interrupted by another one of the plurality of tasks, subtracting a running time of the other of the plurality of tasks from a running time that includes the running time of the at least one of the plurality of tasks and the running time of the other of the plurality of tasks.

2. The method according to claim 1, wherein:
the time interval is selected such that at least two of the plurality of tasks are started and ended during the time interval, and
each running time is determined in a sequence in which each task is completed.

3. The method according to claim 2, wherein:
a variable Unterbr is set to zero before step (A),
the running time of each of the plurality of tasks when completed is determined using the equation t_{runningtime}=t_{end}−tₛₜₐᵣₜ−(Unterbr_{end}−Unterbrₛₜₐᵣₜ), and
a new value for the variable Unterbr is determined using the equation Unterbr=Unterbrₛₜₐᵣₜ+(t_{end}−tₛₜₐᵣₜ), tₛₜₐᵣₜ being a value of a time counter running during an execution of the computer program at a start of each of the plurality of tasks, t_{end} being a value of the time counter at an end of each of the plurality of tasks, Unterbrₛₜₐᵣₜ being a value of the variable Unterbr at the start of each of the plurality of tasks, and Unterbr_{end} being the value of the variable Unterbr at the end of each of the plurality of tasks.

4. The method according to claim 2, further comprising:
storing each running time of each of the plurality of tasks in a respective one of a plurality of individual memory locations of the computing element.

5. The method according to claim 4, wherein:
each of the plurality of individual memory locations includes a random access memory (RAM) memory location.

6. The method according to claim 2, further comprising:
determining the load of the computing element by forming an added value; and
setting the added value in proportion to the time interval after the time interval elapses, wherein the added value is formed by adding together the running times of each of the plurality of tasks.

7. A memory element, comprising:
a control program that when executed on a computing element causes the computing element to:
(A) select a time interval such that at least one of the plurality of tasks is started and ended during the time interval;
(B) determine a running time of the at least one of the plurality of tasks during the time interval after a completion of one of the at least one of the plurality of tasks and each of the plurality of tasks; and
(C) if the at least one of the plurality of tasks was interrupted by another one of the plurality of tasks, subtract a running time of the other of the plurality of tasks from a running time that includes the running time of the at least one of the plurality of tasks and the running time of the other of the plurality of tasks.

8. The memory element according to claim 7, wherein:
the memory element includes one of a read only memory, a random access memory, and a flash memory.

9. The memory element according to claim 7, wherein:
the computing element includes a microprocessor.

10. A computer program for execution on a computing element, wherein the computer program when executed causes the computing element to:
(A) select a time interval such that at least one of the plurality of tasks is started and ended during the time interval;
(B) determine a running time of the at least one of the plurality of tasks during the time interval after a completion of one of the at least one of the plurality of tasks and each of the plurality of tasks; and
(C) if the at least one of the plurality of tasks was interrupted by another one of the plurality of tasks, subtract a running time of the other of the plurality of tasks from a running time that includes the running time of the at least one of the plurality of tasks and the running time of the other of the plurality of tasks.

11. The computer program according to claim 10, wherein:
the computing element includes a microprocessor.

12. The computer program according to claim 10, wherein:
the computer program is stored on a memory element.

13. The computer program according to claim 12, wherein:
the memory element includes a flash memory.

14. A device for determining a load of a computing element on which a computer program is executed, the computer program being subdivided into a plurality of tasks, each of the plurality of tasks including at least one process, comprising:
(A) an arrangement for selecting a time interval such that at least one of the plurality of tasks is started and ended during the time interval;
(B) an arrangement for determining a running time of the at least one of the plurality of tasks during the time interval after a completion of one of the at least one of the plurality of tasks and each of the plurality of tasks; and
(C) an arrangement for, if the at least one of the plurality of tasks was interrupted by another one of the plurality of tasks, subtracting a running time of the other of the plurality of tasks from a running time that includes the running time of the at least one of the plurality of tasks and the running time of the other of the plurality of tasks.

15. The device according to claim 14, wherein:
the time interval is selected such that at least two of the plurality of tasks are started and ended during the time interval, and
each running time is determined in a sequence in which each task is completed.
